(19) United States
(12) Patent Application Publication
(10) Pub. No.: US 2024/0214047 A1
(43) Pub. Date: Jun. 27, 2024

(54) Methods and Apparatuses for Determining Channel State Information Interference Measurement Resources for Interference Measurement

(71) Applicant: Telefonaktiebolaget LM Ericsson (publ), Stockholm (SE)

(72) Inventors: Saad Naveed Ahmed, Sundbyberg (SE); Hong Ren, Kanata (CA); Wei Wang, Kanata (CA)

(21) Appl. No.: 18/288,759

(22) PCT Filed: Apr. 30, 2021
(86) PCT No.: PCT/SE2021/050403

§ 371 Date: Oct. 27, 2023

(51) Int. Cl. H04B 7/06; H04B 17/336; H04W 72/1273; H04W 76/40

(52) U.S. Cl. CPC H04B 7/0626; H04B 17/336; H04W 72/1273; H04W 76/40

(57) ABSTRACT

Embodiments described herein relate to methods and apparatuses for determining channel state information interference measurement, CSI-IM resources for interference measurement in a NR cell, wherein the NR cell is sharing a frequency carrier with a Long Term Evolution, LTE, cell under the control of a LTE base station. A method in an NR base station serving the NR cell comprises: generating a CSI-IM pattern for enabling at least one wireless device to perform interference measurements wherein the CSI-IM pattern comprises at least one CSI-IM resource in an Multicast-Broadcast Single-Frequency Network, MBSFN, slot of the LTE cell and at least one CSI-IM resource in a non-MBSFN slot of the LTE cell; and sending an indication of the CSI-IM pattern to the LTE base station.

### TECHNICAL FIELD

Embodiments described herein relate to methods and apparatuses for determining channel state information interference measurement, CSI-IM resources for interference measurement.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

5G will be introduced on both new and legacy spectrum bands. This may require functionality that enables operators to plan the 5G evolution of network assets including both spectrum bands and technologies, as well as, allowing for a seamless roll-out of 5G with optimal end-user performance. Ericsson Spectrum Sharing, as illustrated in FIG. 1, gives the possibility to intelligently, flexibly and quickly introduce 5G within existing 4G carriers, e.g. to introduce 5G on low/mid bands for wide area coverage and outside in coverage. In an example spectrum sharing implementation software dynamically shares spectrum between 4G and 5G carriers based on traffic demand. The frequency resources between Radio Access Technologies are switched within milliseconds (in some examples one millisecond), which minimizes spectrum wastage and allows for best end-user performance.

A connected NR user may be configured with Channel State Information (CSI) resource elements (REs) which comprise of CSI-Reference Signals (CSI-RS) that are transmitted by the NR base station and CSI-Interference Measurement (CSI-IM) resources which are silenced at the NR base station to enable wireless devices in the cell to measure the interference from neighboring cells. These REs can be configured as periodic as illustrated in FIG. 2a, aperiodic as illustrated in FIG. 2b, or semi-persistent measurements. In either case, the base station (e.g. gNB) refrains from transmitting during the CSI-IM REs and the wireless device measures the interference from neighboring cells and computes channel quality based on the perceived radio conditions. For TDD also the wireless devices refrain from transmitting in the CSI-IM resources that is configured by the serving cell. The channel quality may then be reported by the wireless device to the base station to perform link adaptation.

As illustrated in FIG. 3, the existing spectrum sharing implementation configures CSI-IM in MBSFN slots (e.g. slots 301) as illustrated in FIG. 3. If an MBSFN slot is used only for NR, the wireless device will be able to measure only the NR inter-cell interference. If no LTE traffic is scheduled in MBSFN slots the LTE inter-cell interference may therefore not be measured. This results in incorrect channel quality measurements at the wireless device as the wireless device is only capturing NR neighbor interference.

In current networks, there may be much more LTE traffic than NR traffic, and this may create high downlink inter-cell interference. FIG. 4 illustrates an LTE base station 401 causing interference at an NR base station 402. Due to the current solution, this LTE interference is not measured and reported by an NR wireless device resulting in the channel quality being calculated as being better than the actual channel quality. This optimistic calculated channel quality is then used by the NR base station to perform link adaptation, resulting in a higher Modulation and Coding Scheme (MCS) being used for non-MBSFN slots than the wireless device can handle. This may result in Cyclic Redundancy Check (CRC) errors, resulting in more retransmissions, reducing throughput and increasing Physical Downlink Control Channel (PDCCH) usage.

### SUMMARY

According to some embodiments there is provided a method in a new radio, NR, base station for determining channel state information interference measurement, CSI-IM resources for interference measurement in a NR cell, wherein the NR cell is sharing a frequency carrier with a Long Term Evolution, LTE, cell under the control of a LTE base station. The method comprises generating a CSI-IM pattern for enabling at least one wireless device to perform interference measurements wherein the CSI-IM pattern comprises at least one CSI-IM resource in an Multicast-Broadcast Single-Frequency Network, MBSFN, slot of the LTE cell and at least one CSI-IM resource in a non-MBSFN slot of the LTE cell; and sending an indication of the CSI-IM pattern to the LTE base station.

According to some embodiments there is provided a method in a Long Term Evolution, LTE base station, for enabling configuration, at a new radio, NR, base station, of channel state information interference measurement, CSI-IM resources, for interference measurement in a NR cell served by the NR base station, wherein the NR cell is sharing a frequency carrier with a Long Term Evolution, LTE, cell under the control of the LTE base station. The method comprises receiving an indication of a CSI-IM resource pattern from the NR base station; and for each non-MBSFN slot containing CSI-IM resources according to the CSI-IM resource pattern: responsive to a Physical Downlink Shared Channel, PDSCH, transmission being scheduled for transmission in the non-MBSFN slot, refraining from transmitting data on resource elements used for CSI-IM resources in the non-MBSFN slot; and responsive to a Cell-specific Reference Signal, CRS, being scheduled for transmission in the non-MBSFN slot, muting the CRS on resource elements that are used for CSI-IM resources.

According to some embodiments there is provided a new radio, NR, base station for determining channel state information interference measurement, CSI-IM resources for interference measurement in a NR cell, wherein the NR cell is sharing a frequency carrier with a Long Term Evolution, LTE, cell under the control of an LTE base station. The NR base station comprises processing circuitry configured to: generate a CSI-IM pattern for enabling at least one wireless device to perform interference measurements, wherein the CSI-IM pattern comprises at least one CSI-IM resource in an Multicast-Broadcast Single-Frequency Network, MBSFN, slot of the LTE cell and at least one CSI-IM resource in a non-MBSFN slot of the LTE cell; and send an indication of the CSI-IM pattern to the LTE cell.

According to some embodiments there is provided a Long Term Evolution, LTE base station, for enabling configuration, at a new radio, NR, base station, of channel state information interference measurement, CSI-IM resources, for interference measurement in a NR cell served by the NR base station, wherein NR cell is sharing a frequency carrier with a Long Term Evolution, LTE, cell under the control of the LTE base station. The LTE base station comprises processing circuitry configured to: receive an indication of a CSI-IM resource pattern from the NR base station; for each non-MBSFN slot containing CSI-IM resources according to the CSI-IM resource pattern; and responsive to a Physical Downlink Shared Channel, PDSCH, transmission being scheduled for transmission in the non-MBSFN slot, refrain from transmitting data on resource elements used for CSI-IM resources in the non-MBSFN slot; and responsive to a Cell-specific Reference Signal, CRS, being scheduled for transmission in the non-MBSFN slot, mute the CRS on resource elements that are used for CSI-IM resources.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates Ericsson Spectrum Sharing, with the vertical axis illustrating frequency of the shared frequency carrier and horizontal axis illustrating time/transmission time intervals;

FIG. 2a is a signalling diagram illustrating periodic CSI RS

FIG. 2b is a signaling diagram illustrating aperiodic CSI RS;

FIG. 3 is a scheme of subsequent time slots along the horizontal axis that illustrates CSI-IM configured in MBSFN slots;

FIG. 4 illustrates an LTE base station causing interference at an NR base station;

FIG. 5 illustrates a method in a new radio, NR, base station according to some embodiments;

FIG. 6 is a scheme of subsequent time slots along the horizontal axis that illustrates an example CSI-IM pattern comprising alternative MBSFN and non-MBSFN slots in time according to some embodiments;

FIG. 7 is a diagram of physical radio resources blocks, with subsequent symbols long horizontal axis, and sub-carriers along vertical axis and that illustrates the positioning of CSI-IM resources in a first NR base station (graph 701) and a second NR base station (graph 702);

FIG. 8 illustrates a method in a Long-Term Evolution, LTE base station according to some embodiments;

FIG. 9 is a diagram of physical radio resources blocks, with subsequent symbols long horizontal axis, and sub-carriers along vertical axis and that illustrates: in graph 901 the CSI-IM resources used in an NR base station; in graph 902 the PDSCH, PDCCH and CRS transmissions scheduled by the spectrum sharing LTE base station are illustrated; and in graph 903 the PDSCH, PDCCH and CRS transmissions scheduled by a neighbouring LTE base station;

FIG. 10 is a signalling diagram illustrating an example implementation of the methods of FIGS. 5 and 8;

FIG. 11 illustrates an NR base station 1100 comprising processing circuitry (or logic);

FIG. 12 illustrates an LTE base station 1200 comprising processing circuitry (or logic).

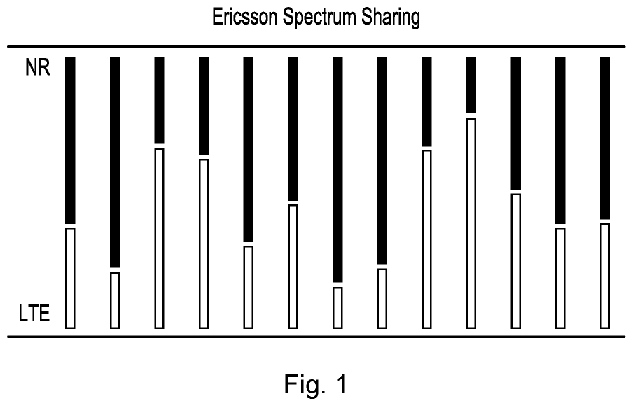

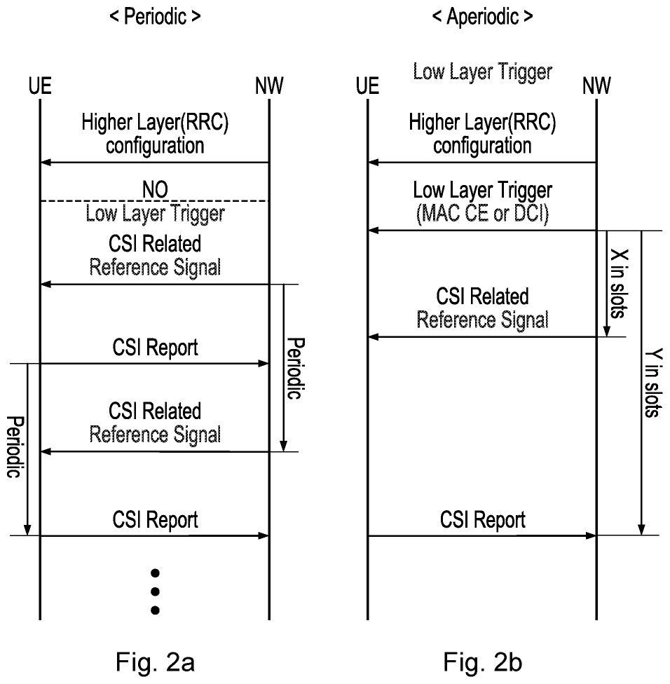

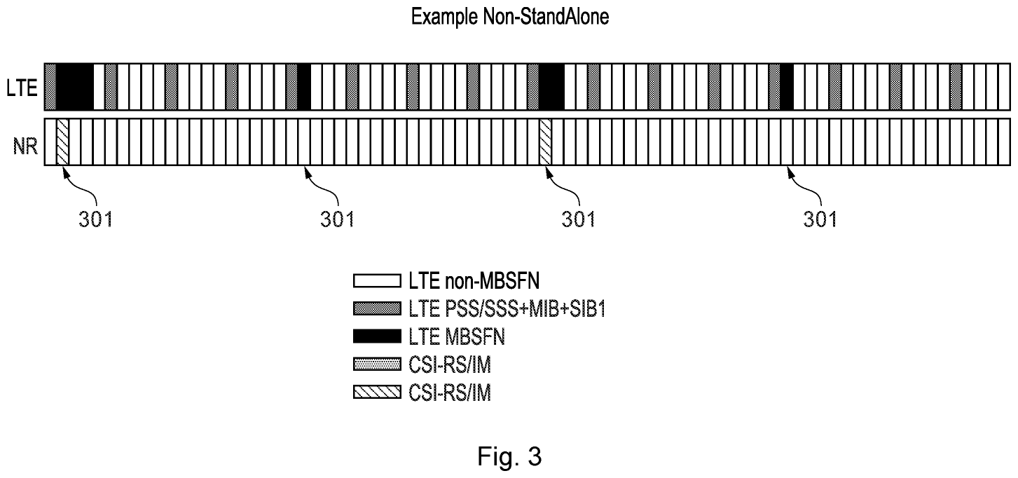

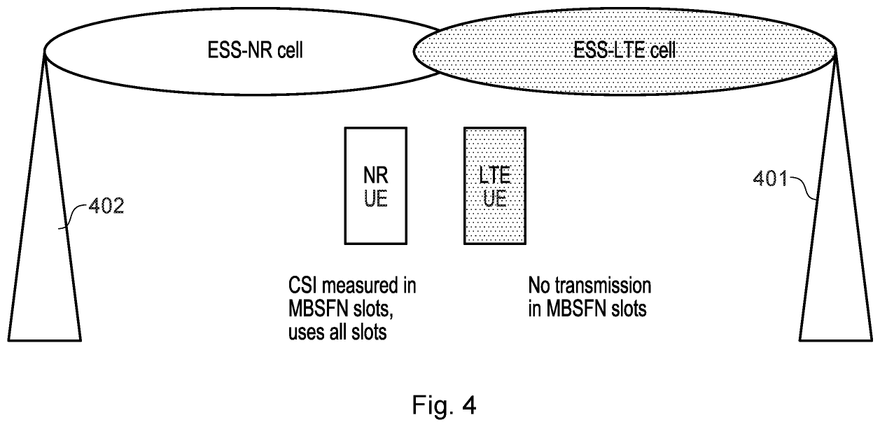

### DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

In embodiments described herein methods and apparatuses are proposed for a New Radio (NR) Radio Access Technology (RAT) to measure Long Term Evolution (LTE) inter-cell interference in a multi RAT system of shared spectrum.

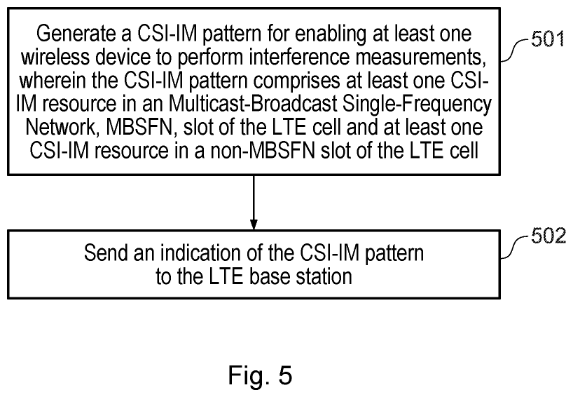

FIG. 5 illustrates a method in a new radio, NR, base station for determining channel state information interference measurement, CSI-IM resources for interference measurement in a NR cell, wherein the NR cell is sharing a frequency carrier with a Long Term Evolution, LTE, cell under the control of a LTE base station. It will be appreciated that transmissions on the NR cell and the LTE cell may be made by the same one or more antennas, or by co-sited antennas. It will also be appreciated that the NR cell and the LTE cell may serve at least partly overlapping areas.

In step 501, the NR base station generates a CSI-IM pattern for enabling at least one wireless device to perform interference measurements (e.g. by measuring the interference from neighbouring cells), wherein the CSI-IM pattern comprises at least one CSI-IM resource in an Multicast-Broadcast Single-Frequency Network, MBSFN, slot of the LTE cell and at least one CSI-IM resource in a non-MBSFN slot of the LTE cell. The CSI-IM pattern is a pattern of resources that are silenced by no transmission in the serving NR cell, or at least transmissions being avoided in the resources of the CSI-IM pattern. Each CSI-IM resource comprises one or more subcarriers in frequency domain and one or more OFDM symbols in time domain.

In other words, the NR base station generates a CSI-IM pattern in symbol (time) and subcarrier (frequency), for example, taking into consideration other LTE and NR control channels. The CSI-IM pattern may for example be generated using a Physical Cell Identity (PCI) of cell.

For example, the position of the CSI-IM (e.g. subcarrier, symbol) may be a function of the PCI of the NR Cell. An example may be to rotate CSI-IM either in time (changing symbols with PCI) or frequency (changing subcarriers with PCI) or both.

In some examples, the CSI-IM pattern is randomly selected from a plurality of valid CSI-IM patterns (for example, as defined by the 3GPP standard).

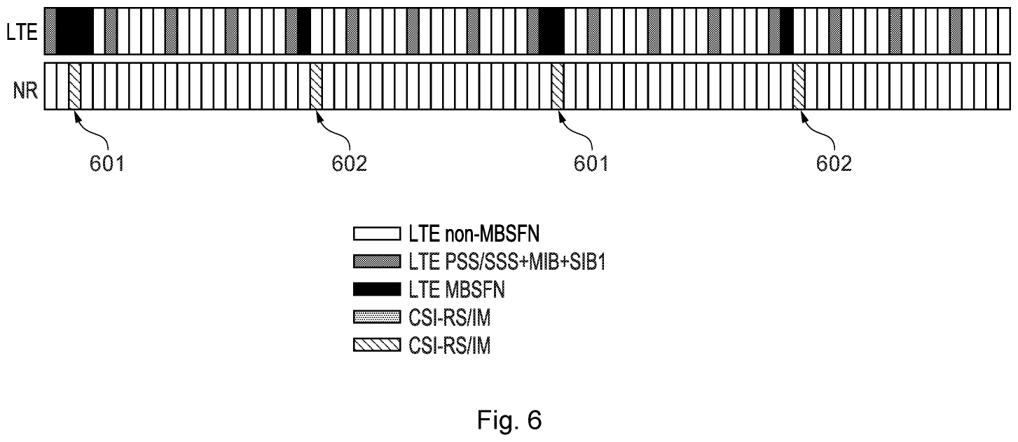

The method as claimed in any preceding claim wherein the CSI-IM pattern comprises alternative MBSFN and non-MBSFN slots in time. For example, as illustrated in FIG. 6, the CSI-IM may be configured at a UE such that in the time domain, one CSI-IM occasion is in an MBSFN slot (e.g. 601) and the next CSI-IM occasion is in a non-MBSFN slot (e.g. 602).

It will be appreciated that an indication of the CSI-IM pattern may be transmitted to the wireless device. The wireless device can then utilize the CSI-IM pattern to perform interference measurements. The interference measurements performed by the wireless device may then be complied into a CSI report.

The NR base station may then receive from a connected wireless device a CSI report comprising measurements of the CSI-IM resources according to the CSI-IM pattern as is generated for the NR cell.

In some examples, the NR base station may track whether CSI report corresponds to a measurement in an MBSFN slot or a non-MBSFN slot.

The NR base station may then perform link adaptation based on the measurements and their associated slot types. For example, link adaptation may adjust as it may consider CSI depending on slot type (MBSFN or non-MBSFN) to adapt the link at transmission occasion. For example, if the CSI report of non-MBSFN slot reports lower channel quality whereas the CSI report of MBSFN slot reports higher channel quality, then link adaptation may use a lower modulation and coding scheme (MCS) for non-MBSFN slots and a higher MCS for MBSFN slots.

In step 502, the NR base station sends an indication of the CSI-IM pattern to the LTE base station. It will be appreciated that this transmission may be transmitted over a wired interface between the LTE base station and the NR base station.

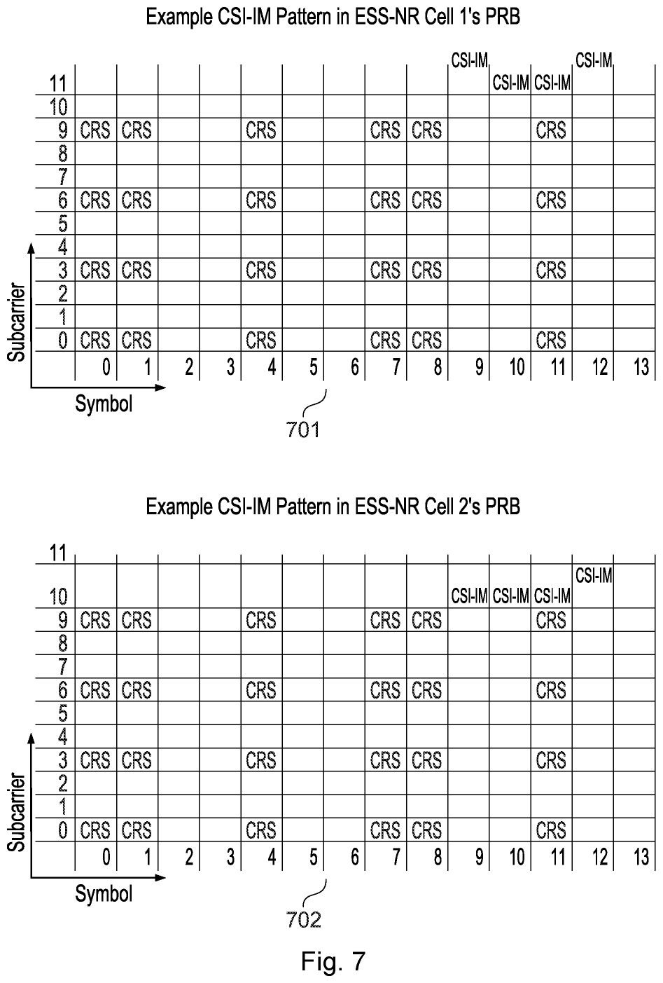

The neighbour NR base station may derive a CSI-IM pattern to position their CSI-IM resources as different to one another as possible. For example, FIG. 7 illustrates the positioning of CSI-IM resources in a first NR base station (graph 701) and a second NR base station (graph 702). In this example, the CSI-IM is shifted in frequency (different subcarriers) for neighbouring base stations. In particular, in this example, the CSI-IM for the first NR base station are placed in subcarrier 11 and the CSI-IM for the second base station are placed in subcarrier 10.

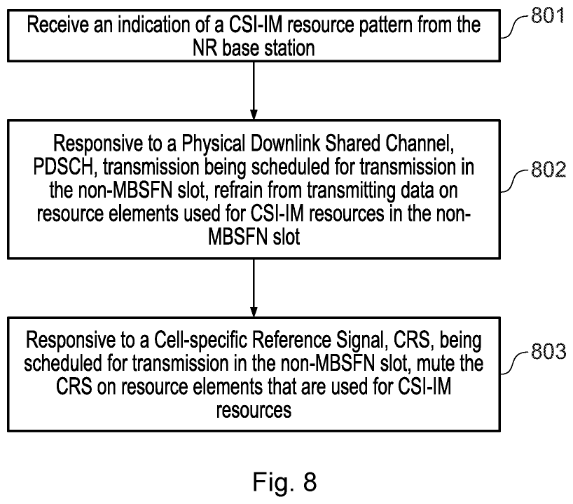

FIG. 8 illustrates a method in a Long Term Evolution, LTE base station, for enabling configuration, at a new radio, NR, base station, of channel state information interference measurement, CSI-IM resources, for interference measurement in a NR cell served by the NR base station, wherein the NR cell is sharing a frequency carrier with a Long Term Evolution, LTE, cell under the control of the LTE base station. It will be appreciated that transmissions on the NR cell and the LTE cell may be made by the same one or more antennas, or by respective antennas that are co-sited. It will also be appreciated that the NR cell and the LTE cell may serve at least partly overlapping areas.

In step 801, the LTE base station receives an indication of a CSI-IM resource pattern from the NR base station.

For each non-MBSFN slot containing CSI-IM resources according to the CSI-IM resource pattern the base station performs steps 802 and 803.

In step 802, the LTE base station, responsive to a Physical Downlink Shared Channel, PDSCH, transmission being scheduled for transmission in the non-MBSFN slot, refrains from transmitting data on resource elements used for CSI-IM resources in the non-MBSFN slot.

In step 803, the LTE base station responsive to a Cell-specific Reference Signal, CRS, being scheduled for transmission in the non-MBSFN slot, mutes the CRS on resource elements that are used for CSI-IM resources.

As neighbour cells will have CSI-IM resources arranged differently, the neighbour LTE base stations may transmit, for example, PDSCH or CRS in the REs that overlap with CSI-IM resources of the serving NR cell.

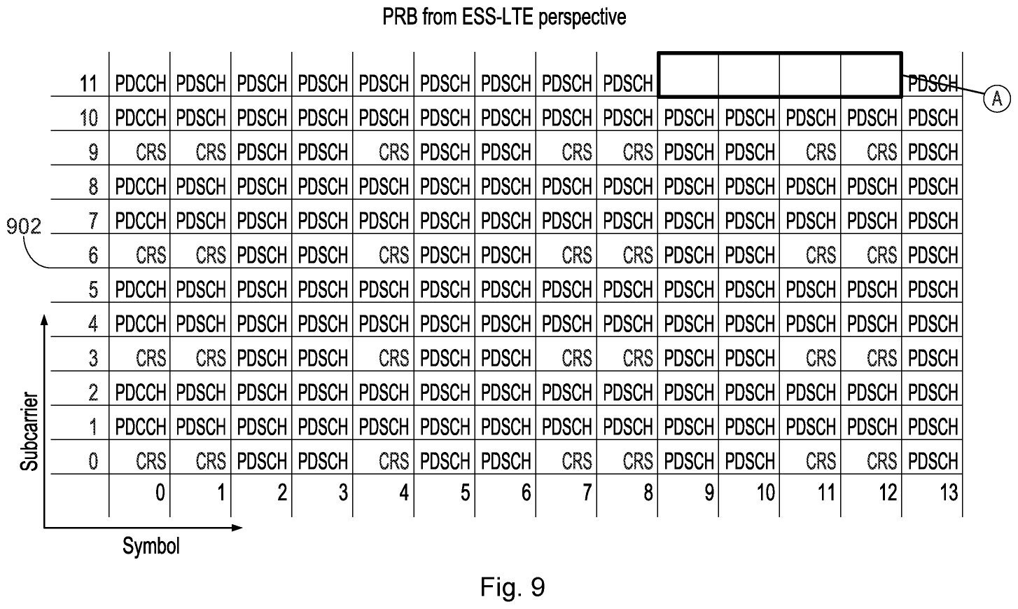

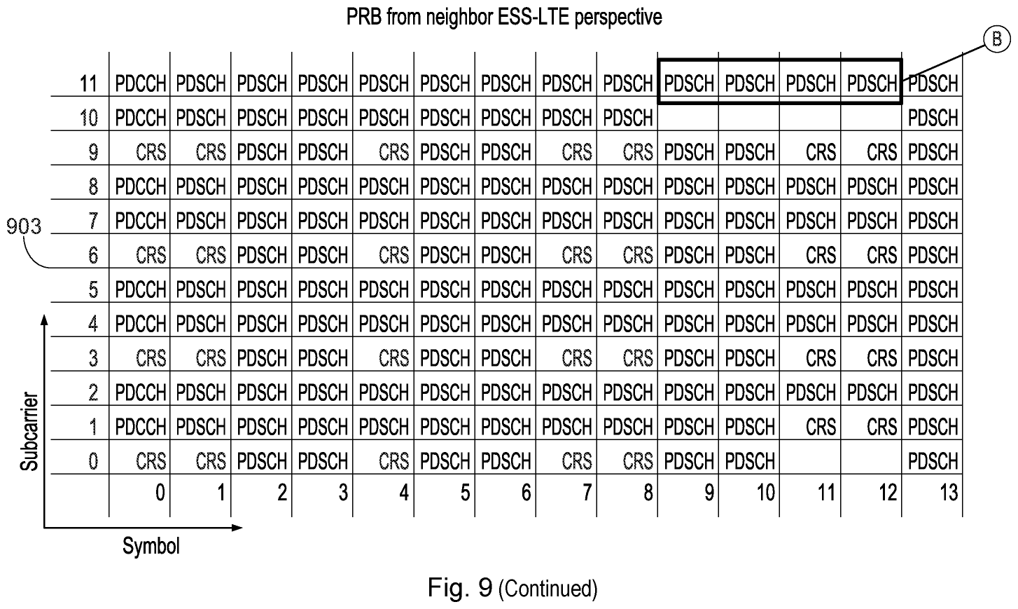

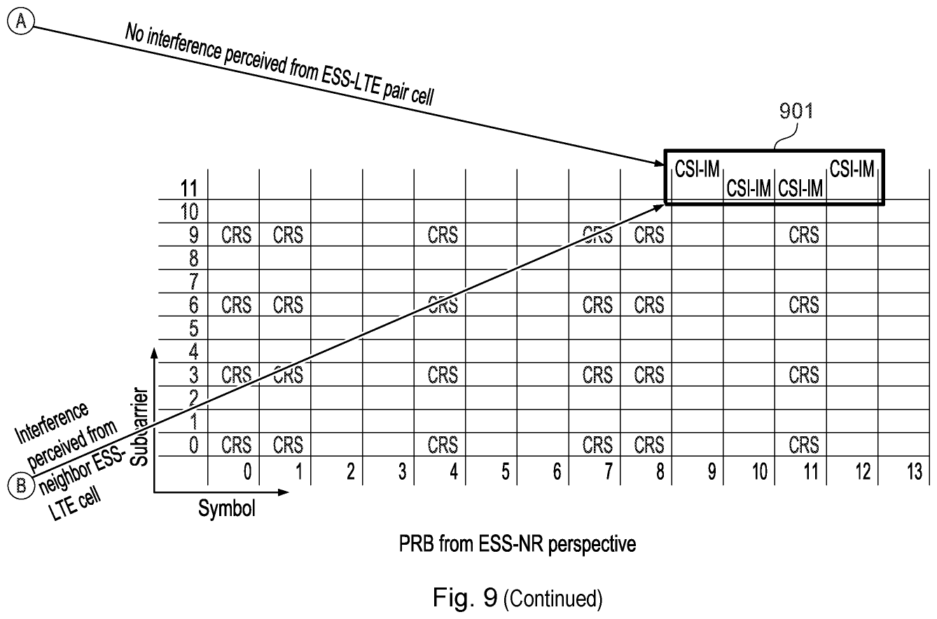

For example, FIG. 9 illustrates in graph 901 the CSI-IM resources used in an NR base station. The PDSCH, PDCCH and CRS transmissions scheduled by the spectrum sharing LTE base station are illustrated in graph 902, and the PDSCH, PDCCH and CRS transmissions scheduled by a neighbouring LTE base station are illustrated in graph 903.

It can be seen from graphs 901, 902 and 903 that the CSI-IM resources in subcarrier 11 for the NR base station (graph 901) do not overlap with any PDSCH or CRS transmissions from the LTE serving base station (graph 902), but they do overlap with the PDSCH transmitted by the neighbour base station (graph 903).

In some examples, CSI-IM resources may overlap with neighbour LTE cells CRS as well as neighbour PDSCH transmissions. In such a configuration, the performed interference measurements in the CSI-IM resources would capture interference due to CRS as well as PDSCH transmissions.

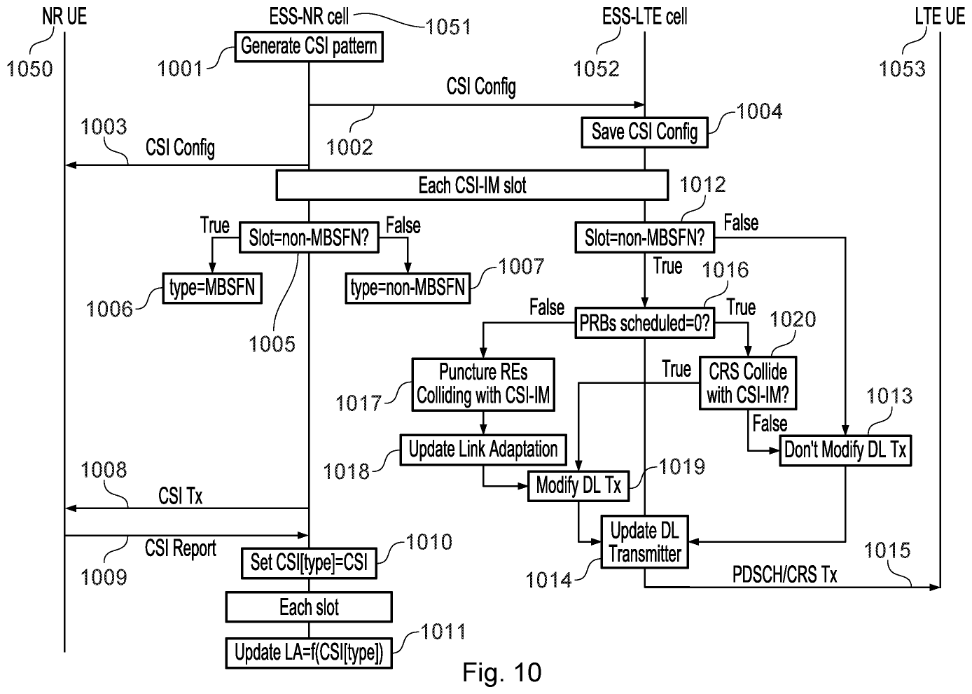

FIG. 10 is a signalling diagram illustrating an example implementation of the methods of FIGS. 5 and 8. The signalling takes place between a NR wireless device 1050, a spectrum sharing NR base station 1051 and the corresponding LTE base station 1052, and an LTE wireless device 1053.

In step 1001 the NR base station 1051 generates a CSI-IM pattern for enabling the connected NR wireless device 1050 to perform interference measurements. Step 1001 may for example correspond to step 501 of FIG. 5.

In step 1002, the NR base station 1051 sends an indication of the CSI-IM pattern to the LTE base station 1052. Step 1002 may for example correspond to step 502 of FIG. 5.

The LTE base station 1052 saves the CSI-IM pattern in step 1003.

In step 1004, the NR base station 1051 transmits an indication of the CSI-IM pattern to the NR wireless device 1050 1050.

For each CSI-IM slot within the CSI-IM pattern, steps 1005 to 1020 may be performed

In step 1005, the NR base station 1051 determines whether the CSI-IM slot comprises an MBSFN slot or a non-MBSFN slot. If the CSI-IM slot comprises an MBFSN slot, a parameter “type” may be set to “MBSFN” in step 1006. If the CSI-IM slot comprises a non-MBSFN slot, a parameter “type” may be set of “non-MBSFN” in step 1007.

In step 1008 the NR base station 1051 refrains from transmitting during the CSI-IM resources according to the CSI-IM pattern. In other words, the CSI-IM resources are transmitted with zero power.

In step 1009, the NR wireless device 1050 makes measurements of the interference during the CSI-IM resources due to transmission from neighboring cells and transmits a CSI report to the NR base station. The CSI report comprises an indication of the interference measured during the CSI resources.

In step 1010, the NR cell keeps track whether CSI reported corresponds to a measurement in MBSFN slot or non-MBSFN slot as determined in step 1005. For example, the NR base station 1051 may augment the CSI measurement provided by the NR wireless device 1050 with the parameter “type” as illustrated in step 1010.

For each slot, the NR base station 1051 may then perform link adaptation, in step 1011, based on the CSI measurement corresponding to that slot provided by the NR wireless device.

Steps 1012 to 1020 may occur concurrently to steps 1005 to 1011.

In step 1012, the LTE base station 1052 determines whether the CSI-IM slot comprises an MBSFN slot or a non-MBSFN slot.

If the CSI-IM slot comprises an MBSFN slot, the method passes to step 1013 in which the LTE base station 1052 determines not to modify the downlink transmission. The method then passes to step 1014 in which any updates to the downlink transmission are passed to the DL transmitter, which then transmits the PDSCH and/or CRS transmission to the LTE wireless device 1054 in step 1015.

If in step 1012, the LTE base station 1052 determines that the CSI-IM slot comprises a non-MBSFN slot, the method passes to step 1016.

In step 1016, the LTE base station 1052 determines whether a PDSCH transmission is scheduled in the non-MBSFN slot.

If in step 1016, the LTE base station 1052 determines that a PDSCH transmission is scheduled in the non-MBSFN slot, the method passes to step 1017 in which the LTE base station 1052 punctures resource elements (REs) colliding with the CSI-IM resources. For example, the LTE base station 1052 may perform PDSCH resource mapping as if the non-MBSFN slot was not configured with any CSI-IM resources, and refrains from transmitting PDSCH resources on any resource element used for CSI-IM resources in the non-MBSFN slot.

The method then passes to step 1018 in which the LTE base station 1052 may update link adaptation based on the punctured REs. For example, the loss of data and interference from caused by step 1017 may be overcome by using a more robust link adaptation e.g. increasing redundancy of the PDSCH transmission by for example, increasing redundancy of other REs in the codeword and/or boosting power on other REs in the codeword etc. This update the link adaptation may be performed so that CSI-IM measured by NR wireless device 1050 does not consider its LTE spectrum sharing cell as interference.

The method then passes to step 1019 in which the LTE base station 1052 determines to modify the downlink transmission. In this case, the modification may be to implement the punctured REs of step 1017 and the updated link adaptation of step 1018. The method then passes to step 1014 and 1015.

If in step 1016, the LTE base station 1052 determines that a PDSCH transmission is not scheduled in the non-MBSFN slot, the method passes to step 1020 in which the base station determines whether any CRS collide with the CSI-IM scheduled during the non-MBSFN slot.

If in step 1020, the LTE base station 1052 determines that no CRS collide with the CSI-IM scheduled during the non-MBSFN slot the method passes to step 1013.

If in step 1020, the LTE base station 1052 determined that CRS do collide with the CSI-IM scheduled during the non-MBSFN slot, the method passes to step 1019. In this case, step 1019 may comprise determining to mute colliding CRS Res. In some examples, step 1019 may also comprise determining to boost non-colliding CRS REs.

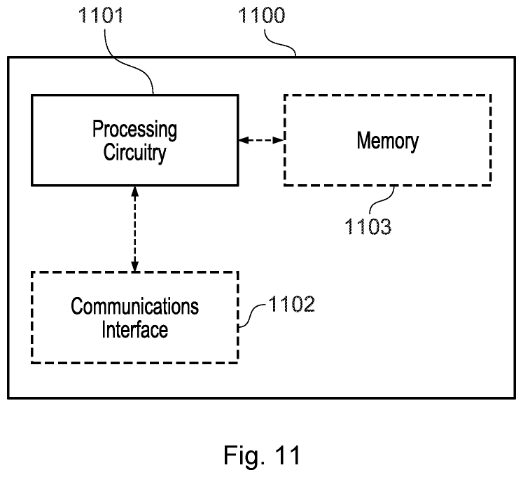

FIG. 11 illustrates an NR base station 1100 comprising processing circuitry (or logic) 1101. The processing circuitry 1101 controls the operation of the NR base station 1100 and can implement the method described herein in relation to an NR base station 1100. The processing circuitry 1101 can comprise one or more processors, processing units, multi-core processors or modules that are configured or programmed to control the NR base station 1100 in the manner described herein. In particular implementations, the processing circuitry 1101 can comprise a plurality of software and/or hardware modules that are each configured to perform, or are for performing, individual or multiple steps of the method described herein in relation to the NR base station 1100.

Briefly, the processing circuitry 1101 of the NR base station 1100 is configured to: generate a CSI-IM pattern for enabling at least one wireless device to perform interference measurements wherein the CSI-IM pattern comprises at least one CSI-IM resource in an Multicast-Broadcast Single-Frequency Network, MBSFN, slot of the LTE cell and at least one CSI-IM resource in a non-MBSFN slot of the LTE cell; and send an indication of the CSI-IM pattern to the LTE base station.

In some embodiments, the NR base station 1100 may optionally comprise a communications interface 1102. The communications interface 1102 of the NR base station 1100 can be for use in communicating with other nodes, such as other virtual nodes. For example, the communications interface 1102 of the NR base station 1100 can be configured to transmit to and/or receive from other nodes requests, resources, information, data, signals, or similar. The processing circuitry 1101 of NR base station 1100 may be configured to control the communications interface 1102 of the NR base station 1100 to transmit to and/or receive from other nodes requests, resources, information, data, signals, or similar.

Optionally, the NR base station 1100 may comprise a memory 1103. In some embodiments, the memory 1103 of the NR base station 1100 can be configured to store program code that can be executed by the processing circuitry 1101 of the NR base station 1100 to perform the method described herein in relation to the NR base station 1100. Alternatively or in addition, the memory 1103 of the NR base station 1100, can be configured to store any requests, resources, information, data, signals, or similar that are described herein. The processing circuitry 1101 of the NR base station 1100 may be configured to control the memory 1103 of the NR base station 1100 to store any requests, resources, information, data, signals, or similar that are described herein.

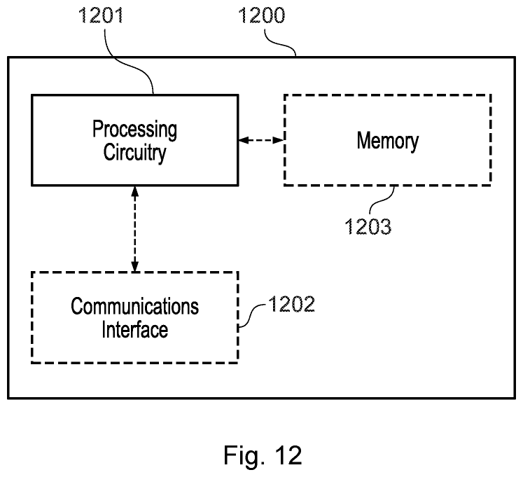

FIG. 12 illustrates an LTE base station 1200 comprising processing circuitry (or logic) 1201. The processing circuitry 1201 controls the operation of the LTE base station 1200 and can implement the method described herein in relation to an LTE base station 1200.

The processing circuitry 1201 can comprise one or more processors, processing units, multi-core processors or modules that are configured or programmed to control the LTE base station 1200 in the manner described herein. In particular implementations, the processing circuitry 1201 can comprise a plurality of software and/or hardware modules that are each configured to perform, or are for performing, individual or multiple steps of the method described herein in relation to the LTE base station 1200.

Briefly, the processing circuitry 1201 of the LTE base station 1200 is configured to: receive an indication of a CSI-IM resource pattern from the NR base station; and for each non-MBSFN slot containing CSI-IM resources according to the CSI-IM resource pattern: responsive to a Physical Downlink Shared Channel, PDSCH, transmission being scheduled for transmission in the non-MBSFN slot, refrain from transmitting data on resource elements used for CSI-IM resources in the non-MBSFN slot; and responsive to a Cell-specific Reference Signal, CRS, being scheduled for transmission in the non-MBSFN slot, mute the CRS on resource elements that are used for CSI-IM resources.

In some embodiments, the LTE base station 1200 may optionally comprise a communications interface 1202. The communications interface 1202 of the LTE base station 1200 can be for use in communicating with other nodes, such as other virtual nodes. For example, the communications interface 1202 of the LTE base station 1200 can be configured to transmit to and/or receive from other nodes requests, resources, information, data, signals, or similar. The processing circuitry 1201 of LTE base station 1200 may be configured to control the communications interface 1202 of the LTE base station 1200 to transmit to and/or receive from other nodes requests, resources, information, data, signals, or similar.

Optionally, the LTE base station 1200 may comprise a memory 1203. In some embodiments, the memory 1203 of the LTE base station 1200 can be configured to store program code that can be executed by the processing circuitry 1201 of the LTE base station 1200 to perform the method described herein in relation to the LTE base station 1200. Alternatively, or in addition, the memory 1203 of the LTE base station 1200, can be configured to store any requests, resources, information, data, signals, or similar that are described herein. The processing circuitry 1201 of the LTE base station 1200 may be configured to control the memory 1203 of the LTE base station 1200 to store any requests, resources, information, data, signals, or similar that are described herein.

Embodiments described herein provide better estimation of radio channel quality by a wireless device as both the interference from NR base stations and LTE base stations may be measured.

This may lead to better decoding performance in slots which are interfered by both LTE and NR neighbor cells; fewer retransmissions resulting in better PRB utilization and higher throughput; and less consumption of control channel resources (e.g. PDCCH).

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-20. (canceled)

21. A method in a new radio (NR) base station for determining channel state information interference measurement (CSI-IM) resources for interference measurement in a NR cell, wherein the NR cell is sharing a frequency carrier with a Long Term Evolution (LTE) cell under the control of a LTE base station, the method comprising:
generating a CSI-IM pattern for enabling at least one wireless device to perform interference measurements wherein the CSI-IM pattern comprises at least one CSI-IM resource in an Multicast-Broadcast Single-Frequency Network (MBSFN) slot of the LTE cell and at least one CSI-IM resource in a non-MBSFN slot of the LTE cell; and
sending an indication of the CSI-IM pattern to the LTE base station.

22. The method of claim 21, further comprising refraining from transmitting any signal or energy during CSI-IM resources indicated by the CSI-IM pattern.

23. The method of claim 21, wherein the CSI-IM pattern is randomly selected from a plurality of valid CSI-IM patterns.

24. The method of claim 21, wherein the CSI-IM pattern is generated based on a cell identification (ID) of the NR base station.

25. The method of claim 21, wherein the CSI-IM pattern comprises alternative MBSFN and non-MBSFN slots in time.

26. The method of claim 21, further comprising:
sending an indication of the CSI-IM pattern to the wireless device.

27. The method of claim 26, further comprising:
receiving from said wireless device a CSI report comprising interference measurements performed in the CSI-IM resources according to the CSI-IM pattern.

28. The method of claim 27, further comprising:
tracking whether a CSI report corresponds to a measurement in an MBSFN slot or a non-MBSFN slot.

29. The method of claim 28, further comprising:
performing link adaptation based on the measurements and their associated slot types.

30. The method of claim 21, wherein transmissions on the NR cell and the LTE cell are made by the same one or more antennas.

31. The method of claim 21, wherein the NR cell and the LTE cell serve at least partly overlapping areas.

32. A method in a Long Term Evolution (LTE) base station, for enabling configuration, at a new radio (NR) base station, of channel state information interference measurement (CSI-IM) resources, for interference measurement in a NR cell served by the NR base station, wherein the NR cell is sharing a frequency carrier with a Long Term Evolution (LTE) cell under the control of the LTE base station, the method comprising:
receiving an indication of a CSI-IM resource pattern from the NR base station; and
for each non-MBSFN slot containing CSI-IM resources according to the CSI-IM resource pattern:
responsive to a Physical Downlink Shared Channel (PDSCH) transmission being scheduled for transmission in the non-MBSFN slot, refraining from transmitting data on resource elements used for CSI-IM resources in the non-MBSFN slot; and
responsive to a Cell-specific Reference Signal, CRS, being scheduled for transmission in the non-MBSFN slot, muting the CRS on resource elements that are used for CSI-IM resources.

33. The method of claim 32, further comprising:
responsive to a PDSCH transmission being scheduled in the non-MBSFN slot, performing PDSCH resource mapping as if the non-MBSFN slot was not configured with any CSI-IM resources, and
refraining from transmitting PDSCH resources on any resource element used for CSI-IM resources in the non-MBSFN slot.

34. The method of claim 33, further comprising increasing redundancy of the PDSCH transmission.

35. A new radio (NR) base station for determining channel state information interference measurement (CSI-IM) resources for interference measurement in a NR cell, wherein the NR cell is sharing a frequency carrier with a Long Term Evolution (LTE) cell under the control of an LTE base station, the NR base station comprising processing circuitry configured to:
generate a CSI-IM pattern for enabling at least one wireless device to perform interference measurements, wherein the CSI-IM pattern comprises at least one CSI-IM resource in an Multicast-Broadcast Single-Frequency Network (MBSFN) slot of the LTE cell and at least one CSI-IM resource in a non-MBSFN slot of the LTE cell; and
send an indication of the CSI-IM pattern to the LTE cell.

36. The NR base station of claim 35, wherein the processing circuitry is further configured to refrain from transmitting any signal or energy during CSI-IM resources indicated by the CSI-IM pattern.

37. A Long Term Evolution (LTE) base station, for enabling configuration, at a new radio (NR) base station, of channel state information interference measurement (CSI-IM) resources, for interference measurement in a NR cell served by the NR base station, wherein NR cell is sharing a frequency carrier with a Long Term Evolution (LTE) cell under the control of the LTE base station, the LTE base station comprising processing circuitry configured to:
receive an indication of a CSI-IM resource pattern from the NR base station;
for each non-MBSFN slot containing CSI-IM resources according to the CSI-IM resource pattern; and
responsive to a Physical Downlink Shared Channel (PDSCH) transmission being scheduled for transmission in the non-MBSFN slot, refrain from transmitting data on resource elements used for CSI-IM resources in the non-MBSFN slot; and
responsive to a Cell-specific Reference Signal, CRS, being scheduled for transmission in the non-MBSFN slot, mute the CRS on resource elements that are used for CSI-IM resources.

38. The LTE base station of claim 37, wherein the processing circuitry is further configured to:
responsive to a PDSCH transmission being scheduled in the non-MBSFN slot, perform PDSCH resource mapping as if the non-MBSFN slot was not configured with any CSI-IM resources, and
refrain from transmitting PDSCH resources on any resource element used for CSI-IM resources in the non-MBSFN slot.

39. A non-transitory computer-readable medium comprising, stored thereupon, computer program comprising instructions configured so as to, when executed on at least one processor, cause the at least one processor to carry out a method according to claim 21.

40. A non-transitory computer-readable medium comprising, stored thereupon, computer program comprising instructions configured so as to, when executed on at least one processor, cause the at least one processor to carry out a method according to claim 32.
